(19) United States
(12) Patent Application Publication
(10) Pub. No.: US 2025/0068323 A1
(43) Pub. Date: Feb. 27, 2025

(54) IMAGE PROCESSING APPARATUS, IMAGE PROCESSING METHOD, AND RECORDING MEDIUM

(71) Applicants: Kwansei Gakuin Educational Foundation, Hyogo (JP); MICWARE CO., LTD., Hyogo (JP)

(72) Inventor: Kazutoshi SUMIYA, Hyogo (JP)

(21) Appl. No.: 18/799,894

(22) Filed: Aug. 9, 2024

(30) Foreign Application Priority Data
Aug. 25, 2023 (JP) 2023-137057

(51) Int. Cl. G06F 3/0487; G06F 3/0484; G06V 10/40; G06V 10/75

(52) U.S. Cl. CPC G06F 3/0487; G06F 3/0484; G06V 10/40; G06V 10/751

(57) ABSTRACT

An image processing apparatus includes a correspondence manager that stores two or more pieces of correspondence information each indicating a correspondence between an operation-string definition that defines a set of operation identifiers corresponding respectively to two or more operations and an intention identifier that identifies an intention of the operations; a first output unit that outputs a first image associated with positional information; an operation-string acceptor that accepts input of an operation string that is a set of operation identifiers that respectively identify two or more operations performed on the first image; an intention-string acquirer that acquires, from the correspondence manager, an intention string corresponding to the operation string accepted by the operation-string acceptor; a second output unit that outputs a second image; and an operation unit that performs, on the second image, operations corresponding to the intention string acquired by the intention-string acquirer.

### TECHNICAL FIELD

The present invention relates to an image processing apparatus or the like that performs processing on position images that are images associated with positional information such as street view imagery.

### BACKGROUND ART

There is conventionally technology for improving the usability of street view imagery. More specifically, there are conventionally street view systems that improve usability in consideration of landscape images to be displayed and usage patterns of mobile terminals and thereby allow users who visit towns for social-studies field tips or any other purposes to see landscape information from the height of a desired point of view (see Patent Literature (PTL) 1).

### CITATION LIST

### Patent Literature

PTL 1: Japanese Patent No. 6390992

### SUMMARY OF INVENTION

### Technical Problem

It is, however, difficult with the conventional technology to divert the intention of operations performed on one position image to the other position images, the position images being associated with positional information.

### Solution to Problem

An image processing apparatus according to one aspect of the present invention includes a correspondence manager that stores two or more pieces of correspondence information each indicating a correspondence between an operation-string definition and an intention identifier, the operation-string definition defining a set of operation identifiers that correspond respectively to two or more operations, the intention identifier identifying an intention of the two or more operations, a first output unit that outputs an image associated with positional information as a first image, an operation-string acceptor that accepts input of an operation string that is a set of operation identifiers that respectively identify two or more operations performed on the first image, an intention-string acquirer that acquires an intention string from the correspondence manager, the intention string being a set of intention identifiers that correspond respectively to one or more operation-string definitions that match the operation string accepted by the operation-string acceptor, a second output unit that outputs a second image, and an operation unit that performs one or more operations on the second image, the one or more operations satisfying the operation-string definition corresponding to the intention string acquired by the intention-string acquirer.

This configuration enabling diverting the intention of operations performed on the first image to the second image, and as a result, allows automatic manipulation of the second image according to the user's intention.

### BRIEF DESCRIPTION OF DRAWINGS

FIG. 1 is a block diagram of an image processing apparatus 1 according to Embodiment 1.

FIG. 2 is a flowchart for describing a first operation example of the image processing apparatus 1.

FIG. 3 is a flowchart for describing a first example of intention-string acquisition processing.

FIG. 4 is a flowchart for describing a second example of the intention-string acquisition processing.

FIG. 5 is a flowchart for describing an example of feature-of-interest determination processing.

FIG. 6 is a flowchart for describing an example of image determination processing.

FIG. 7 is a flowchart for describing an example of image manipulation processing.

FIG. 8 is a flowchart for describing an example of intention execution processing.

FIG. 9 is a flowchart for describing a second operation example of the image processing apparatus 1.

FIG. 10 is a flowchart for describing an example of the image manipulation processing.

FIG. 11 is a diagram for describing an example of a concept of the image processing apparatus 1.

FIG. 12 shows correspondence tables or the like.

FIG. 13 shows a screen image.

FIG. 14 is a diagram for describing processing for acquiring an intention string.

FIG. 15 shows a correspondence table.

FIG. 16 shows a screen image.

FIG. 17 is a block diagram of an image processing apparatus 2 according to Embodiment 2.

FIG. 18 is a flowchart for describing an operation example of the image processing apparatus 2.

FIG. 19 is a flowchart for describing an example of the image manipulation processing.

FIG. 20 is an overview image of a computer system according to the embodiments described above.

FIG. 21 is a block diagram of the computer system.

### DESCRIPTION OF EMBODIMENTS

Embodiments of an image processing apparatus or the like will be described hereinafter with reference to the drawings. Note that constituent elements that are given the same reference signs in the embodiments perform similar operations, and therefore redundant descriptions thereof may be omitted.

### Embodiment 1

The present embodiment describes an image processing apparatus for acquiring an operation string that represents a set of one or more operations performed on a first image, the first image being an image associated with positional information, then acquires an intention string that represents a set of intentions of the operations based on the operation string, and performs operations responsive to the intention string on a second image. Note that normally the image processing apparatus does not use the operation string used for the first image as-is in the operations of the second image.

The present embodiment also describes an image processing apparatus for acquiring a chunk string that represents a set of one or more chunks from the operation string used for the first image, then acquires an intention string from the chunk string, and performs operations responsive to the intention string on the second image.

The present embodiment also describes an image processing apparatus for acquiring a feature of interest in the first image and performs operations on a feature of the second image that is of the same category as the category of the feature of interest.

The present embodiment also describes an image processing apparatus for manipulating the second image by making adjustments corresponding to an attribute value of a target feature in the second image, instead of using the operation string used for the first image as-is in the operations of the second image.

The present embodiment also describes an image processing apparatus for selecting one or more second images and manipulating each of the one or more second images. In this case, the image processing apparatus selects one or more second images that satisfy a condition of the position relative to the first image.

The present embodiment also describes an image processing apparatus for selecting one or more second images and manipulating each of the one or more second images by using the operation string used for the first image in a mode in which each of the one or more second images is compared with the first image.

The present embodiment further describes a case in which the first image and the second image are images of different types.

In the specification of the present invention, information X associated with information Y means that the information Y can be acquired from the information X or the information X can be acquired from the information Y, and the method of associating them does not matter here. Alternatively, the information X may be linked with the information Y, the information X and the information Y may be stored in the same buffer, the information X may be included in the information Y, or the information Y may be included in the information X.

In the specification of the present invention, determining or selecting the information Z may mean, for example, acquiring the information Z, acquiring a pointer to the information Z, acquiring the ID of the information Z, or setting a flag for the information Z as long as the information Z is accessible.

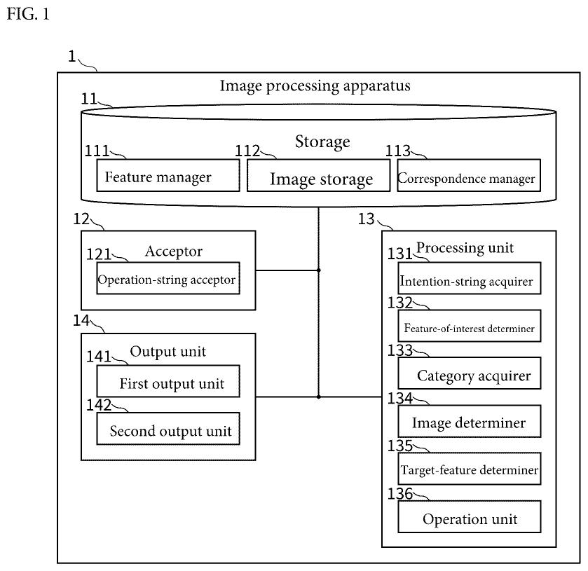

FIG. 1 is a block diagram of an image processing apparatus 1 according to the present embodiment. The image processing apparatus 1 may be a standalone apparatus, or may be a server that receives instructions or information from terminal devices (not shown) and transmits position images to the terminal devices. In the case where the image processing apparatus 1 is a standalone apparatus, for example, the image processing apparatus 1 may be a so-called personal computer, smartphone, or tablet terminal, and the type of the apparatus does not matter here. In the case where the image processing apparatus 1 is a server, for example, the image processing apparatus 1 may be a cloud server or an ASP server, and the type of the server does not matter here.

The image processing apparatus 1 includes a storage 11, an acceptor 12, a processing unit 13, and an output unit 14. The storage 11 includes a feature manager 111, an image storage 112, and a correspondence manager 113. The acceptor 12 includes an operation-string acceptor 121. The processing unit 13 includes an intention-string acquirer 131, a feature-of-interest determiner 132, a category acquirer 133, an image determiner 134, a target-feature determiner 135, and an operation unit 136. The output unit 14 includes a first output unit 141 and a second output unit 142.

The storage 11 of the image processing apparatus 1 stores a variety of information. Examples of the variety of information include feature information described later, position images described later, and correspondence information described later. Note that the feature manager 111, the image storage 112, and the correspondence manager 113 may be included in an external server (not shown).

The feature manager 111 stores two or more pieces of feature information. The feature information refers to information about features. The features are normally objects that are present on the ground, but may also include objects that are present indoors. The features may also be referred to as objects. Examples of the features include buildings, parks, bridges, rivers, and mountains.

Each piece of feature information includes a feature identifier and one or more feature attribute values. The feature identifier is information for use in identifying the feature. The feature identifier may, for example, be the ID or name of the feature. The feature attribute values are attribute values for the feature. It is preferable that the one or more feature attribute values include a category and positional information. The category refers to the type of the feature. Examples of the category include “Pub”, “School”, “University/College”, “Conveyor-Belt Sushi Shop”, “Park”, and “Museum”. It is preferable that the one or more feature attribute values include two or more pieces of positional information. It is preferable that the one or more feature attribute values included in each piece of feature information include regional information for use in identifying a region of the feature. The regional information normally includes two or more pieces of positional information. The positional information is information for use in identifying the position. The positional information may preferably be information for use in identifying the position in a three-dimensional space, but it may be information for use in identifying the position in a two-dimensional space. For example, the positional information may be expressed as (latitude, longitude, height), or may be expressed as (latitude, longitude).

The image storage 112 stores two or more position images. The position images are images each associated with one or two or more pieces of positional information. The position images are normally captured images. The position images are images targeted for operation. Note that the contents of the operation do not matter here.

The images associated with the positional information may be images including positional information. Examples of the positional information include street view imagery, three-dimensional images, indoor images, and drive recorder images. Examples of the three-dimensional images include Google Earth (registered trademark) images. The indoor images are images obtained by capturing an image of the indoors. The indoor images may, for example, be images acquired by LiDAR. The drive recorder images are images captured by a drive recorder installed in a mobile unit.

As described above, the image storage 112 may be included in an external server, instead of being included in the image processing apparatus 1. Examples of the external server include a Google Earth server and a server that manages street view imagery.

The correspondence manager 113 stores two or more pieces of correspondence information. Each piece of correspondence information indicates a correspondence between an operation string and an intention identifier. The operation string represents a set of one or two or more operation identifiers. A set of operation identifiers is a time-series string of operation identifiers.

For example, each piece of correspondence information may include an operation-string definition and an intention identifier. The operation-string definition is information for defining the operation string. The operation-string definition is information for defining a set of two or more operation identifiers. It is preferable that the operation-string definition is a description of one or more operation identifiers using a regular expression. The intention identifier is information for use in identifying the intention. For example, the intention identifier may be the ID or name of the intention. The intention refers to the intention of an operation. It is preferable that the two or more pieces of correspondence information are each associated with one image-type identifier. The image-type identifier is information for use in identifying the type of the image. Examples of the image-type identifier include “street view imagery”, a “three-dimensional image”, an “indoor image”, or a “drive recorder image”.

The correspondence information may include, for example, first correspondence information and second correspondence information. The first correspondence information is information indicating correspondences between operation-string definitions and chunk identifiers. Each chunk identifier is information for use in identifying the chunk. The chunk is a cluster of operations. The chunk is a set of one or two or more operations. The chunk identifier is the ID or name of the chunk. The second correspondence information is information indicating correspondences between chunk-string definitions and intention identifiers. Each chunk-string definition is the definition of a chunk string that is a set of one or more chunk identifiers. It is preferable that the chunk-string definition is a description of one or more chunk identifiers using a regular expression. It is preferable that the first correspondence information and the second correspondence information are each associated with one image-type identifier.

The acceptor 12 accepts input of a variety of instructions and information. Examples of the variety of instructions and information include an operation string used for a first image, an output instruction, an operation end instruction, and the correspondence information. The operation string is a set of operation identifiers for use in identifying each of two or more operations. The first image is a position image targeted for user's operation.

The output instruction is an instruction to output the first image. The output instruction normally includes an image identifier. The image identifier is a position image identifier. Examples of the image identifier include a uniform resource locator (URL) and a filename.

The operation end instruction is an instruction to end the operation that is performed on the first image. For example, the operation end instruction may be an instruction to disable the showing of the first image.

The language “accept” as used herein may refer to, for example, the reception of information transmitted from a user's terminal device (not shown) via a wired or wireless communication line, but it may represent a concept that includes the acceptance of information input from an input device such as a keyboard, a mouse, or a touch panel or the acceptance of information read out from a recording medium such as an optical disk, a magnetic disk, or semiconductor memory.

Means for inputting the variety of instructions and information may be any means implemented as a touch panel, a keyboard, a mouse, or a menu screen.

The operation-string acceptor 121 accepts input of an operation string that represents a set of operation identifiers for respectively identifying two or more operations performed on the first image. Note that the operations performed on the first image are user operations. For example, the operation-string acceptor 121 may accept input of an operation string from a user, or may receive input of an operation string from a user's terminal device (not shown). Each operation may, for example, be any of “Shift”, “leftward turn”, “rightward turn”, “upward turn”, “downward turn”, “Scale-up”, and “Scale-down”. However, the contents of the operations do not matter here.

The processing unit 13 performs a variety of processing. For example, the variety of processing may be processing performed by the intention-string acquirer 131, processing performed by the feature-of-interest determiner 132, processing performed by the category acquirer 133, processing performed by the image determiner 134, processing performed by the target-feature determiner 135, or processing performed by the operation unit 136.

The processing unit 13 acquires a first image that corresponds to the output instruction. For example, the processing unit 13 may acquire the first image from an image server (not shown). Or, for example, the processing unit 13 may acquire the first image from the image storage 112.

The processing unit 13 stores the correspondence information accepted by the acceptor 12 in the correspondence manager 113.

The intention-string acquirer 131 acquires an intention string from the correspondence manager 113, the intention string representing one or more intention identifiers that correspond respectively to one or more operation-string definitions that match the operation string accepted by the operation-string acceptor 121. For example, the intention-string acquirer 131 may acquire the intention string by acquiring the image-type identifier of an image targeted for operation and using the correspondence information corresponding to the image-type identifier.

For example, the intention-string acquirer 131 may acquire a chunk string from two or more pieces of first correspondence information, the chunk string representing a set of one or more chunk identifiers that correspond respectively to one or more operation-string definitions that match the operation string accepted by the operation-string acceptor 121. Then, for example, the intention-string acquirer 131 may acquire one or more intention identifiers from two or more pieces of second correspondence information, the one or more intention identifies corresponding to chunk-string definitions that match the chunk string.

The feature-of-interest determiner 132 references to the feature manager 111 and determines a feature of interest by using the positional information associated with the first image, the feature of interest being an image in the first image and matching a condition of interest. The feature-of-interest determiner 132 normally determines one feature of interest, but may determine two or more features of interest.

The condition of interest is a condition for determining the feature of interest. The condition of interest is normally a condition concerning the positional information on the feature. For example, the condition of interest may be a condition that the feature has been present for the longest time in a direction in which the user is oriented. The condition of interest may also be, for example, that the feature has been present for the longest time in a central region that is the range within a threshold value from the center point of the first image. The condition of interest may also be, for example, that the feature is present in the last first image among all first images on which the operation has been performed and is also present in a central region that is the range within a threshold value from the center point of the last first image. The condition of interest may also be, for example, that the feature is present in the last first image among all first images on which the operation has been performed and is also present in a direction in which the user is oriented. Note that the direction in which the user is oriented may, for example, be a direction in which a focal point (e.g., a cursor position or a center point) in the first image shifts.

The category acquirer 133 acquires the category from the feature manager 111, the category being an attribute value of the feature of interest determined by the feature-of-interest determiner 132.

The image determiner 134 determines one or more second images. For example, the image determiner 134 may acquire, from the image storage 112, one or more position images that include a feature of the same category as the category acquired by the category acquirer 133. The feature included in the position images is a feature whose position identified by the positional information on the feature is included in the region identified by the regional information corresponding to the position image. Note that each position image acquired by the image determiner 134 is a second image.

In the case where the first image and the second image are position images of different types, for example, the image determiner 134 may determine one or more second images that include the same feature as the feature of interest in the first image.

For example, the image determiner 134 may determine one or more second images that include a feature of the same category as the category acquired by the category acquirer 133 and that are associated with positional information that satisfies the condition of the position with respect to the positional information associated with the first image. For example, the image determiner 134 may determine one or more second images associated with positional information that is positional information on a feature of the same category as the category acquired by the category acquirer 133 and that satisfies the condition of the position with respect to the positional information associated with the first image. The condition of the position may, for example, be that the proximity of the distance of each second image and the first image is less than or equal to top N (N is a natural number greater than or equal to 1) or that this distance is less than or less than or equal to a threshold value.

The target-feature determiner 135 determines a target feature in each of the one or more second images determined by the image determiner 134. The target feature is a feature of the same category as the category acquired by the category acquirer 133.

The operation unit 136 performs one or more operations on each of the one or more second images determined by the image determiner 134, the one or more operations satisfying the operation-string definition corresponding to the intention string acquired by the intention-string acquirer 131. For example, for each of the one or more two images determined by the image determiner 134, the operation unit 136 may acquire an image-type identifier and acquire an operation-string definition by using two or more pieces of correspondence information corresponding the acquired image-type identifier (these pieces of correspondence information may also be referred to as a correspondence table), so that one or more operations that satisfy the acquired operation-string definition are performed on each of the one or more second images.

For example, the operation unit 136 may perform one or more operations on the target feature, the one or more operations respectively satisfying one or more operation-string definitions that correspond to each intention identifier acquired by the intention-string acquirer 131. Performing operations on the target feature is equivalent to performing operations on the second images including the target feature. In the case of performing operations on the target feature determined by the target-feature determiner 135, for example, the operation unit 136 may use the positional information on the target feature so as to maintain a positional relationship that conforms to the intentions identified by the intention identifiers with respect to the target feature. In the case of performing operations on the target feature, for example, the operation unit 136 may change an iteration count for the chunk identifier, change the selection of the chunk identifier, change an iteration count for an operation identifier, or change the selection of the operation identifier by using the positional information on the target feature, so as to maintain a positional relationship that conforms to the intentions identified by the intention identifiers with respect to the target feature. Note that the positional information on the target feature as used herein is normally two or more pieces of positional information and is regional information for use in identifying the region in which the target feature is present.

The operation unit 136 performs one or more operations on each of the one or more second images determined by the image determiner 134, the one or more operations respectively satisfying one or more operation-string definitions that correspond to each intention identifier acquired by the intention-string acquirer 131.

In the case where the operation unit 136 applies intentions to the target feature, there are cases in which operation strings that identify user's operations performed on the first image cannot be applied as-is to the second images due to reasons such as a difference in geographic features between the first image and each second image. This requires the operation unit 136 to modify the operations performed by the user, depending on the feature. For example, in the case where no more operations cannot be performed on the second images, the operation unit 136 does not perform operations beyond a limit in order to avoid the occurrence of such a situation that operations such as “advance” are continued even after a road shown in each second image has come to a dead end. Moreover, for example, in the case where the intention identifier denotes “outward appearances” as will be described later, the operation unit 136 may modify the operation string used for the first image and perform operations on the second images by using the modified operation string, because the first image and the second images may differ in the direction to travel or the angle of turn at an intersection. For example, in the case where the intention identifier denotes “outward appearances” and the distance to travel differs between the first image and each second image, the operation unit 136 may add or delete an operation identifier that denotes “advance” in order to allow a shift across the target feature. In the case where the road shown in the first image and the road shown in each second image differ in the angle of turn, the operation unit 136 may make modifications to change the number of operations of “leftward turn” or “rightward turn” or the angle of each turn so that the roads ahead of each turn become parallel

The output unit 14 outputs a variety of information. Examples of the variety of information include the first image and one or more second images.

The language “output” as used herein refers to, for example, transmission of the information to a user's terminal device (not shown), but it may represent a concept that includes, for example, display of the information on a display, projection of the information via a projector, printing of the information using a printer, transmission of the information to other external devices, storage of the information in a recording medium, and transfer of the result of processing the information to other processing devices or programs.

The first output unit 141 outputs a first image associated with the positional information. A trigger that causes the first output unit 141 to output the first image does not matter here. For example, the first output unit 141 may output the first image when an output instruction has been accepted.

The second output unit 142 outputs second images. For example, the second output unit 142 may output each of the one or more second images determined by the image determiner 134. The second output unit 142 normally outputs second images that vary with operations performed by the operation unit 136. Note that the output of the second images may be considered as being performed by the operation unit 136.

It is preferable that the storage 11, the feature manager 111, the image storage 112, and the correspondence manager 113 are realized as nonvolatile recording media, but they may also be realized as volatile recording media.

The process of storing information in the storage 11 or the like does not matter here. For example, information may be stored in the storage 11 or the like via a recording medium, or information transmitted via a communication line may be stored in the storage 11 or the like. As another alternative, information input via an input device may be stored in the storage 11 or the like.

It is preferable that the acceptor 12 and the operation-string acceptor 121 are realized as wired or wireless communication means, but they may be realized as any other means such as means for receiving a broadcast, a device driver for input means such as a touch panel or a keyboard, or software for controlling a menu screen.

The processing unit 13, the intention-string acquirer 131, the feature-of-interest determiner 132, the category acquirer 133, the image determiner 134, the target-feature determiner 135, and the operation unit 136 may be normally realized as, for example, processors or memory. The procedure of processing performed by the processing unit 13 or the like is normally realized by software that is recorded on a recording medium such as a ROM. Alternatively, the procedure of processing may be realized by hardware (a dedicated circuit). Note that the processor may, for example, be a CPU, a MPU, or a GPU, and the type of the processor does not matter here.

The output unit 14, the first output unit 141, and the second output unit 142 are normally realized as wired or wireless communication means, but they may be realized as driver software for output devices such as a display or a speaker, or may be realized as a combination of an output device and driver software for the output device.

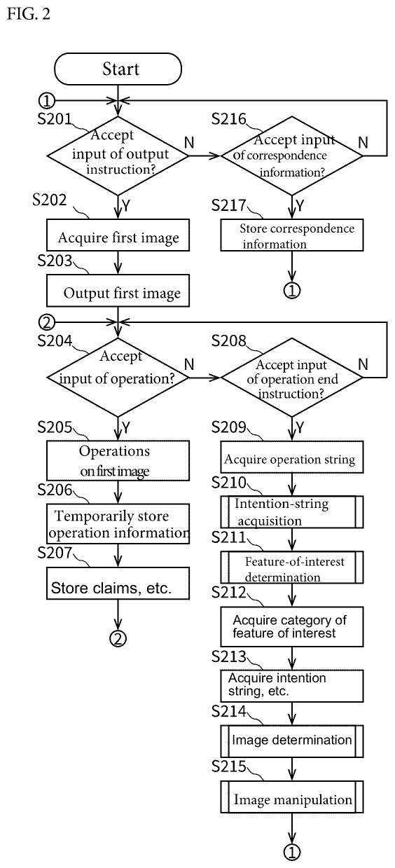

Next, a first operation example of the image processing apparatus 1 will be described with reference to the flowchart in FIG. 2.

(S201) The acceptor 12 determines whether an output instruction has been accepted. If the output instruction has been accepted, the processing proceeds to S202, and if not, then the processing proceeds to S216.

(S202) The processing unit 13 acquires a first image that corresponds to the output instruction accepted in S201.

(S203) The first output unit 141 outputs the first image acquired in S202.

(S204) The operation-string acceptor 121 determines whether an operation performed on the output first image has been accepted. If the operation has been accepted, the processing proceeds to S205, and if not, then the processing proceeds to S208.

(S205) The operation unit 136 acquires a first image that has been modified in accordance with the operation accepted in S204. The second output unit 142 outputs the modified first image.

(S206) The operation unit 136 acquires an operation identifier that identifies the operation accepted in S204, and temporarily stores the acquired operation identifier in a buffer (not shown). For example, operation identifiers that identify operations including “Shift”, “leftward turn”, “rightward turn”, “upward turn”, “downward turn”, “Scale-up”, and “Scale-down” are expressed respectively as “m”, “I”, “r”, “u”, “d”, “i”, and “o”.

(S207) The processing unit 13 temporarily stores a frame that is the modified first image after the operation in a buffer (not shown). Then, the processing returns to S204. The frame is associated with one or more pieces of positional information.

(S208) The acceptor 11 determines whether an operation end instruction has been accepted. If the operation end instruction has been accepted, the processing proceeds to S209, and if not, then the processing proceeds to S204.

(S209) The intention-string acquirer 131 acquires an operation string that is a set of one or more operation identifiers from a buffer (not shown).

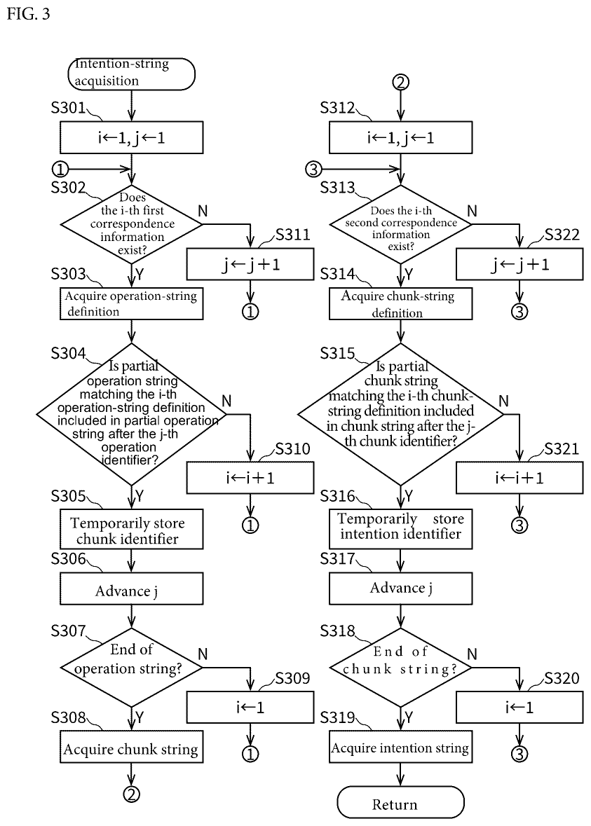

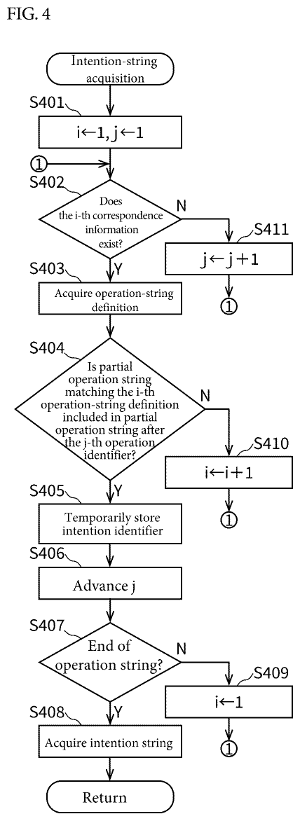

(S210) The intention-string acquirer 131 acquires an intention string that corresponds to the operation string acquired in S209. An example of this intention-string acquisition processing will be described later with reference to the flowchart in FIG. 3 or 4.

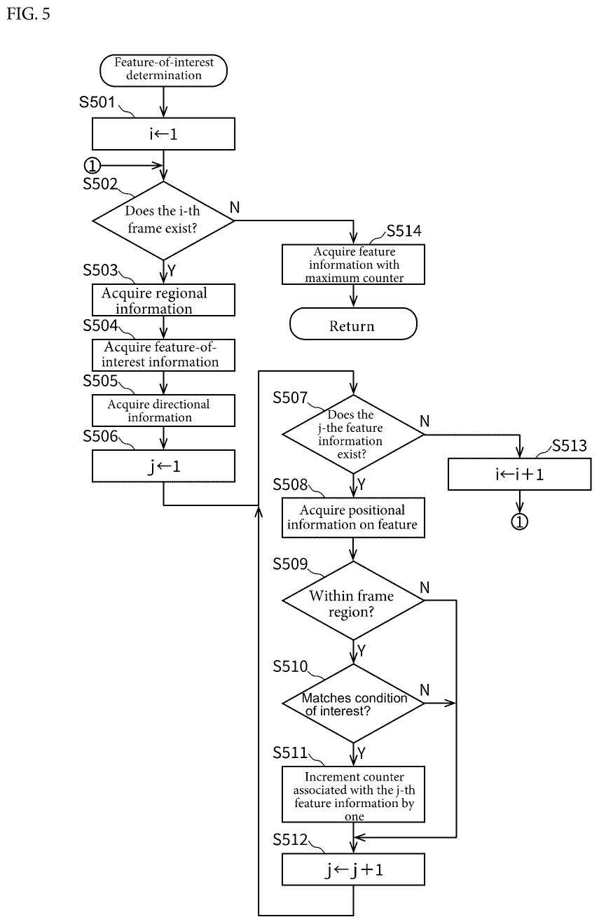

(S211) The feature-of-interest determiner 132 determines a feature of interest in the first image. An example of this feature-of-interest determination processing will be described later with reference to the flowchart in FIG. 5.

(S212) The category acquirer 133 acquires a category in the feature information of the feature of interest determined in S211 from the feature manager 111.

(S213) The intention-string acquirer 131 stores the intention string acquired in S209 and the category acquired in S212 in a buffer (not shown).

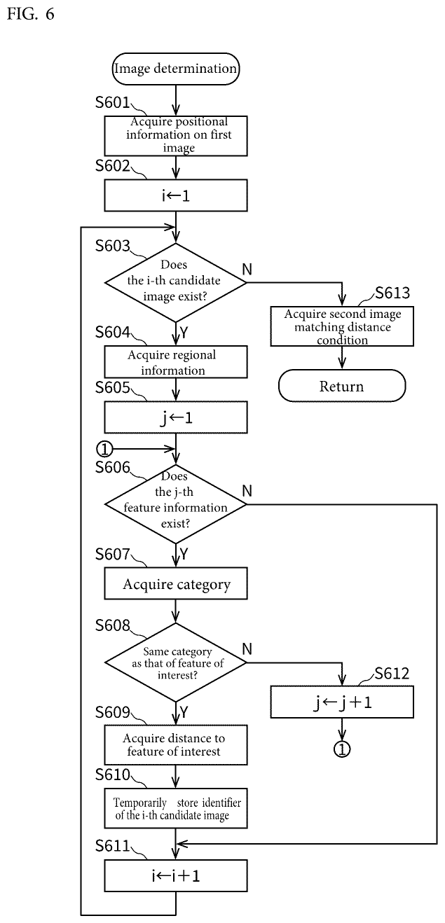

(S214) The image determiner 134 determines one or two or more second images. An example of this image determination processing will be described later with reference to the flowchart in FIG. 6.

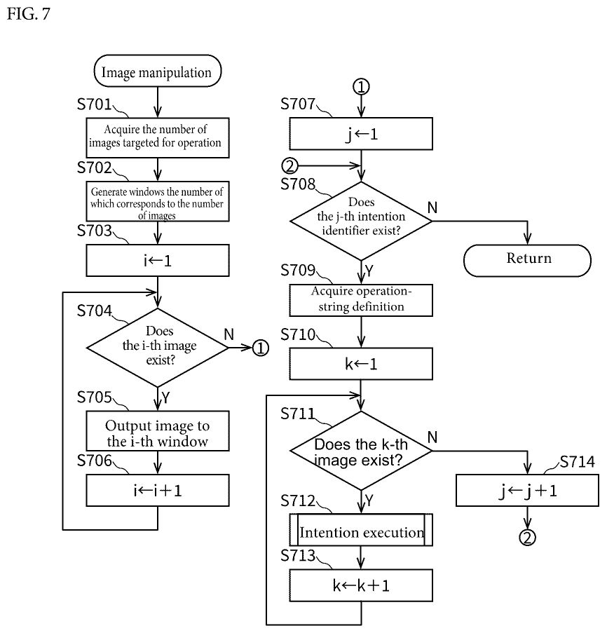

(S215) The operation unit 136 performs an operation responsive to the intention string stored in S213 on two or more images including the one or more second images determined in S214. An example of this image manipulation processing will be described later with reference to the flowchart in FIG. 7.

(S216) The acceptor 12 determines whether correspondence information has been accepted. If the correspondence information has been accepted, the processing proceeds to S217, and if not, then the processing proceeds to S201.

(S217) The processing unit 13 stores the correspondence information accepted in S216 in the correspondence manager 113. Then, the processing returns to S201.

In the flowchart in FIG. 2, the processing ends at power-off or upon receipt of an interrupt request to end the processing.

Next, a first example of the intention-string acquisition processing in S210 will be described with reference to the flowchart in FIG. 3.

(S301) The intention-string acquirer 131 substitutes one into counters i and j.

(S302) The intention-string acquirer 131 determines whether the i-th first correspondence information exists in the correspondence manager 113. If the i-th first correspondence information exists, the processing proceeds to S303, and if not, then the processing proceeds to S311.

(S303) The intention-string acquirer 131 acquires an operation-string definition included in the i-th first correspondence information from the correspondence manager 113.

(S304) The intention-string acquirer 131 determines whether a partial operation string that matches the operation-string definition acquired in S303 exists among a partial operation string that is a set of one or more continuous operation identifiers after the j-th operation identifier. If the partial operation string exists, the processing proceeds to S305, and if the partial operation string does not exist, the processing proceeds to S310.

(S305) The intention-string acquirer 131 acquires a chunk identifier that pairs with the operation-string definition acquired in S303 from the i-th first correspondence information and temporarily stores the acquired chunk identifier in a buffer (not shown).

(S306) The intention-string acquirer 131 advances j to the next operation identifier after the partial operation string that has a maximum length and matches the operation-string definition in S304.

(S307) The intention-string acquirer 131 determines whether j that has been advanced in S306 is in the next position after the last operation identifier of the operation string acquired in S209 (whether the operation string ends). If the operation string ends, the processing proceeds to S308, and if not, then the processing proceeds to S309.

(S308) The intention-string acquirer 131 acquires a chunk string that represents one or more chunk identifiers from a buffer (not shown).

(S309) The intention-string acquirer 131 substitutes one into the counter i. Then, the processing returns to S302.

(S310) The intention-string acquirer 131 increments the counter i by one. Then, the processing returns to S302.

(S311) The intention-string acquirer 131 increments the counter j by one. Then, the processing returns to S302.

(S312) The intention-string acquirer 131 substitutes one into the counters i and j.

(S313) The intention-string acquirer 131 determines whether the i-th second correspondence information exists in the correspondence manager 113. If the i-th second correspondence information exists, the processing proceeds to S314, and if not, then the processing proceeds to S322.

(S314) The intention-string acquirer 131 acquires a chunk-string definition included in the i-th second correspondence information from the correspondence manager 113.

(S315) The intention-string acquirer 131 determines whether a partial chunk string that matches the chunk-string definition acquired in S314 is included in a partial chunk string that is a set of one or more continuous chunk identifiers after the j-th chunk identifier. If the partial chunk string is included, the processing proceeds to S316, and if the partial chunk string is not included, the processing proceeds to S321.

(S316) The intention-string acquirer 131 acquires an intention identifier that pairs with the chunk-string definition acquired in S315 from the i-th second correspondence information and stores the acquired intention identifier in a buffer (not shown).

(S317) The intention-string acquirer 131 advances j to the next chunk identifier after the partial chunk string that has a maximum length and matches the chunk-string definition in S315.

(S318) The intention-string acquirer 131 determines whether j that has been advanced in S317 is in the next position after the last chunk identifier of the chunk string acquired in S308 (whether the chunk string ends). If the chunk string ends, the processing proceeds to S319, and if not, then the processing proceeds to S320.

(S319) The intention-string acquirer 131 acquires an intention string that represents one or more intention identifiers from a buffer (not shown). Then, the processing proceeds to the upper-level processing.

(S320) The intention-string acquirer 131 substitutes one into the counter i. Then, the processing returns to S313.

(S321) The intention-string acquirer 131 increments the counter i by one. Then, the processing returns to S313.

(S322) The intention-string acquirer 131 increments the counter j by one. Then, the processing returns to S313.

Next, a second example of the intention-string acquisition processing in S210 will be described with reference to the flowchart in FIG. 4.

(S401) The intention-string acquirer 131 substitutes one into the counters i and j.

(S402) The intention-string acquirer 131 determines whether the i-th correspondence information exists in the correspondence manager 113. If the i-th correspondence information exists, the processing proceeds to S403, and if not, then the processing proceeds to S411.

(S403) The intention-string acquirer 131 acquires an operation-string definition included in the i-th correspondence information from the correspondence manager 113.

(S404) The intention-string acquirer 131 determines whether a partial operation string that matches the operation-string definition acquired in S403 is included in a partial operation string that is a set of one or more continuous operation identifiers after the j-th operation identifier. If the partial operation string exists, the processing proceeds to S405, and if not, then the processing proceeds to S410.

(S405) The intention-string acquirer 131 acquires an intention identifier that pairs with the operation-string definition acquired in S403 from the i-th correspondence information and temporarily stores the acquired intention identifier in a buffer (not shown).

(S406) The intention-string acquirer 131 advances j to the operation identifier next to the partial operation string that has a maximum length and matches the operation-string definition in S404.

(S407) The intention-string acquirer 131 determines whether j that has been advanced in S406 is in the next position after the last operation identifier of the operation string acquired in S209 (i.e., whether the operation string ends). If the operation string ends, the processing proceeds to S408, and if not, then the processing proceeds to S409.

(S408) The intention-string acquirer 131 acquires an intention string that is a set of one or more intention identifiers from a buffer (not shown). Then, the processing returns to the upper-level processing.

(S409) The intention-string acquirer 131 substitutes one into the counter i. Then, the processing returns to S402.

(S410) The intention-string acquirer 131 increments the counter i by one. Then, the processing returns to S402.

(S411) The intention-string acquirer 131 increments the counter j by one. Then, the processing returns to S402.

Next, an example of the feature-of-interest determination processing performed in S211 will be described with reference to the flowchart in FIG. 5.

(S501) The feature-of-interest determiner 132 substitutes one into the counter i.

(S502) The feature-of-interest determiner 132 determines whether the i-th frame is included in the frames that have been stored in the buffer (not shown) in S207. If the i-th frame exists, the processing proceeds to S503, and if not, then the processing proceeds to S514.

(S503) The feature-of-interest determiner 132 acquires range information for use in identifying the range of a region captured in the i-th frame. For example, the feature-of-interest determiner 132 may acquire the range information from the resolution of the frame and positional information associated with the i-th frame (positional information on representative points). For example, the feature-of-interest determiner 132 may acquire the range information associated with the i-th frame. The range information may, for example, be information that indicates a range in a three-dimensional space and expressed as, for example, “(x1, y1, h1) (x2, y2, h2)”.

(S504) The feature-of-interest determiner 132 acquires position-of-interest information associated with the i-th frame. The position-of-interest information is information for use in identifying the position of a point of interest in the frame or positional information on a focal point and may be expressed as, for example, (x, y, h).

(S505) The feature-of-interest determiner 132 acquires directional information corresponding to the i-th frame. The directional information is information indicating direction, and for example, may be the angle viewed from true north and any of numerical values from 0 to 360. The directional information is information that indicates a direction that may be acquired from a difference in point-of-interest information between two continuous frames.

(S506) The feature-of-interest determiner 132 substitutes one into the counter j.

(S507) The feature-of-interest determiner 132 determines whether the j-th feature information exists in the feature manager 111. If the j-th feature information exists, the processing proceeds to S508, and if not, then the processing proceeds to S513.

(S508) The feature-of-interest determiner 132 acquires positional information included in the j-th feature information from the feature manager 111.

(S509) The feature-of-interest determiner 132 determines whether a j-th feature exists within a region captured in the i-th frame, by using the regional information acquired in S503 and the positional information acquired in S508. If the j-th feature exists within the region captured in the i-th frame, the processing proceeds to S510, and if not, then the processing proceeds to S512.

(S510) The feature-of-interest determiner 132 determines whether positional information on the j-th feature acquired in S508 matches a condition of interest. If the positional information matches the condition of interest, the processing proceeds to S511, and if not, then the processing proceeds to S512.

(S511) The feature-of-interest determiner 132 increments a counter associated with the j-th feature information by one. Note that the counter associated with each piece of feature information has an initial value of zero.

(S512) The feature-of-interest determiner 132 increments the counter j by one. Then, the processing returns to S507.

(S513) The feature-of-interest determiner 132 increments the counter i by one. Then, the processing returns to S502.

(S514) The feature-of-interest determiner 132 acquires feature information associated with the counter that shows a maximum value. Then, the processing returns to the upper-level processing.

Although only one piece of feature information has been acquired in the flowchart in FIG. 5, two or more pieces of feature information may be acquired. In that case, for example, the feature-of-interest determiner 132 may acquire pieces of feature information whose counter values are greater than or equal to a threshold value or top N pieces of feature information that have high counter value (where N is a natural number greater than or equal to one) in S514.

Next, an example of the image determination processing performed in S214 will be described with reference to the flowchart in FIG. 6.

(S601) The image determiner 134 acquires the positional information on the first image.

(S602) The image determiner 134 substitutes one into the counter i.

(S603) The image determiner 134 determines whether there is the i-th candidate image that can be a second image. If the i-th candidate image exists, the processing proceeds to S604, and if not, then the processing processes to S613. Note that the i-th candidate image may, for example, be a position image that exists in the image storage 112 or in an image server (not shown).

(S604) The image determiner 134 acquires regional information for use in identifying a region captured in the i-th candidate image.

(S605) The image determiner 134 substitutes one into the counter j.

(S606) The image determiner 134 determines whether the j-th feature information exists in the feature manager 111. If the j-th feature information exists, the processing proceeds to S607, and if not, then the processing proceeds to S611.

(S607) The image determiner 134 acquires the category of the j-th feature information from the feature information.

(S608) The image determiner 134 determines whether the category acquired in S607 is the same as the category of the feature of interest in the first image. If these two categories are the same, the processing proceeds to S609, and if not, then the processing proceeds to S612.

(S609) The image determiner 134 acquires the distance between the two features by using the positional information on the feature of interest and the positional information included in the j-th feature information and associates the acquired distance with the j-th feature information.

(S610) The image determiner 134 pairs the distance with the identifier of the i-th candidate image and temporarily stores this pair in a buffer (not shown).

(S611) The image determiner 134 increments the counter i by one. Then, the processing returns to S603.

(S612) The image determiner 134 increments the counter j by one. Then, the processing returns to S606.

(S613) The image determiner 134 determines and acquires one or more candidate images whose distances paired respectively with the one or more candidate images stored in S610 match a distance condition, as one or more second images. Then, the processing returns to the upper-level processing. The distance condition as used herein may, for example, be that the distance is one of top three distances with small values or that the distance is equal to or smaller than a threshold value or smaller than the threshold value.

In the flowchart in FIG. 6, in the case where the first image and the second image(s) are position images of different types, the image determiner 134 may acquire one or more second images that include the same feature as the feature of interest existing in the first image.

Next, an example of the image manipulation processing performed in S215 will be described with reference to the flowchart in FIG. 7.

(S701) The operation unit 136 acquires the number of images on which operations using the acquired intention string are performed. The images on which the operations are performed are usually the first image and the one or more second images acquired in S613. That is, the number of images is normally expressed as “the number of images acquired in S613+1”. Alternatively, the images on which the operations are performed may be only the one or more second images acquired in S613.

(S702) The operation unit 136 generates windows, the number of which corresponds to the number of images acquired in S701.

(S703) The operation unit 136 substitutes one into the counter i.

(S704) The operation unit 136 determines whether there is the i-th image targeted for the operations. If there is the i-th image, the processing proceeds to S705, and if not, then the processing proceeds to S707.

(S705) The operation unit 136 acquires the i-th image targeted for the operations and outputs the acquired i-th image to the i-th window.

(S706) The operation unit 136 increments the counter i by one. Then, the processing returns to S704.

(S707) The operation unit 136 substitutes one into the counter j.

(S708) The operation unit 136 determines whether the j-th intention identifier is included in the acquired intention string. If the j-th intention identifier exists, the processing proceeds to S709, and if not, then the processing returns to upper-level processing.

(S709) The operation unit 136 references to the correspondence manager 113 and acquires the operation-string definition corresponding to the j-th intention identifier.

(S710) The operation unit 136 substitutes one into the counter k.

(S711) The operation unit 136 determines whether there is the k-th image targeted for the operations. If the k-th image exists, the processing proceeds to S712, and if not, then the processing proceeds to S714.

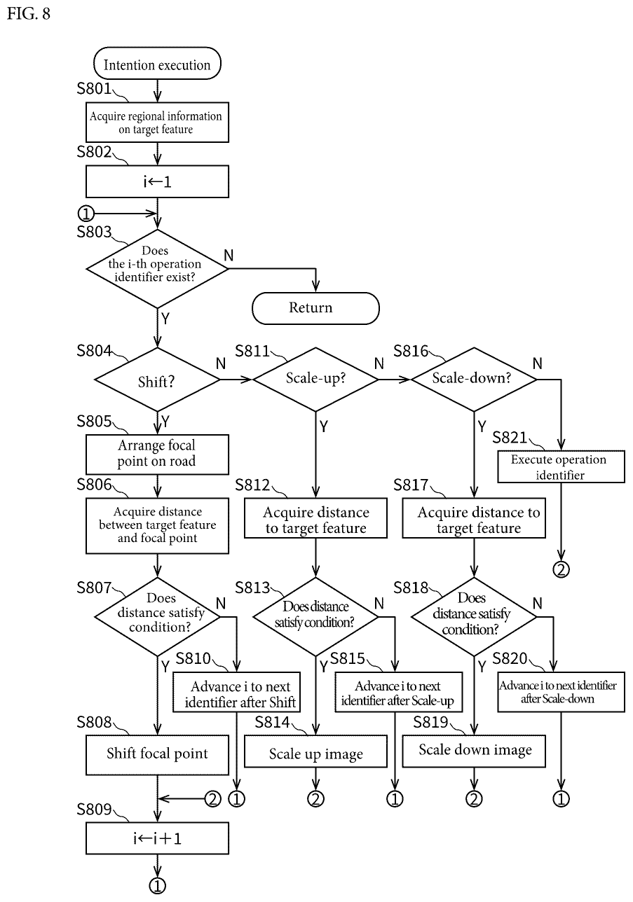

(S712) The operation unit 136 performs operations corresponding to the j-th intention identifier on the k-th image by using the operation-string definition acquired in S709. An example of this intention execution processing will be described later with reference to the flowchart in FIG. 8.

(S713) The operation unit 136 increments a counter k by one. Then, the processing returns to S711.

(S714) The operation unit 136 increments the counter j by one. Then, the processing returns to S708.

Next, the example of the intention execution processing performed in S712 will be described with reference to the flowchart in FIG. 8.

(S801) The operation unit 136 acquires regional information on a target feature in the second image targeted for the operations.

(S802) The operation unit 136 substitutes one into the counter i.

(S803) The operation unit 136 determines whether there is the i-th operation identifier within the operation-string definition. If the i-th operation identifier exists, the processing proceeds to S804, and if not, then the processing returns to the upper-level processing.

(S804) The operation unit 136 determines whether the i-th operation identifier represents “Shift”. If the i-th operation identifier represents “Shift”, the processing proceeds to S805, and if not, then the processing proceeds to S811.

(S805) The operation unit 136 arranges the focal point on a road in the image targeted for operations. For example, the operation unit 136 may determine the focal point as a point on the road that is closest to the center position of the image targeted for the operations.

(S806) The operation unit 136 acquires the distance between the target feature and the focal point.

(S807) The operation unit 136 determines whether the distance acquired in S806 satisfies a condition. If the distance satisfies the condition, the processing proceeds to S808, and if not, then the processing proceeds to S810. The condition as used herein may, for example, be expressed as “first threshold value distance second threshold value”. That is, it is considered inappropriate if the focal point comes too close to or too far from the target feature during shift, and the shift stops.

(S808) The operation unit 136 acquires the image whose focal point has been shifted. Note that the amount of shift may, for example, be a predetermined unit quantity. The image whose focal point has been shifted is an image that has been advanced by the amount of shift.

(S809) The operation unit 136 increments the counter i by one. Then, the processing returns to S803.

(S810) The operation unit 136 advances i until the operation identifier indicated by i becomes the next operation identifier after the operation identifiers representing “Shift” in the operation-string definition. Then, the processing returns to S803.

(S811) The operation unit 136 determines whether the i-th operation identifier represents “Scale-up”. If the i-th operation identifier represents “Scale-up”, the processing proceeds to S812, and if not, then the processing proceeds to S816.

(S812) The operation unit 136 acquires positional information on the target feature and positional information on the focal point and acquires the distance between the target feature and the focal point by using the acquired two pieces of positional information.

(S813) The operation unit 136 determines whether the distance acquired in S812 satisfies a condition. If the distance satisfies the condition, the processing proceeds to S814, and if not, then the processing proceeds to S815. Note that the condition as used herein may, for example, be expressed as “third threshold value s distance s fourth threshold value”. That is, it is determined inappropriate if the focal point comes too close to or too far from the target feature during scale-up (zoom-in), and the scale-up stops.

(S814) The operation unit 136 scales up the image targeted for the operations. Then, the processing proceeds to S809. Note that the degree of scale-up is normally a predetermined unit quantity.

(S815) The operation unit 136 advances j until the operation identifier indicated by i becomes the next operation identifier after the operation identifiers representing “Scale-up” in the operation-string definition. Then, the processing returns to S803.

(S816) The operation unit 136 determines whether the i-th operation identifier represents “Scale-down”. If the i-th operation identifier represents “Scale-down”, the processing proceeds to S817, and if not, then the processing proceeds to S821.

(S817) The operation unit 136 acquires positional information on the target feature and positional information on the focal point and acquires the distance between the target feature and the focal point by using the acquired two pieces of positional information.

(S818) The operation unit 136 determines whether the distance acquired in S817 satisfies a condition. If the distance satisfies the condition, the processing proceeds to S819, and if not, then the processing proceeds to S820. Note that the condition as used herein may, for example, be expressed as “fifth threshold value s distance s sixth threshold value”. That is, it is determined in appropriate if the focal point comes too close to or too far from the target feature during scale-down (zoom-out), and the scale-down stops.

(S819) The operation unit 136 scales down the image targeted for the operations. Then, the processing proceeds to S809. Note that the degree of scale-down is normally a predetermined unit quantity.

(S820) The operation unit 136 advances i until the operation identifier indicated by i becomes the next operation identifier after the operation identifiers representing “Scale-down” in the operation-string definition. Then, the processing returns to S803.

(S821) The operation unit 136 executes the operation recognized by the operation identifier. Then, the processing returns to S809. Examples of the operation include “leftward turn”, “rightward turn”, “upward turn”, and “downward turn”.

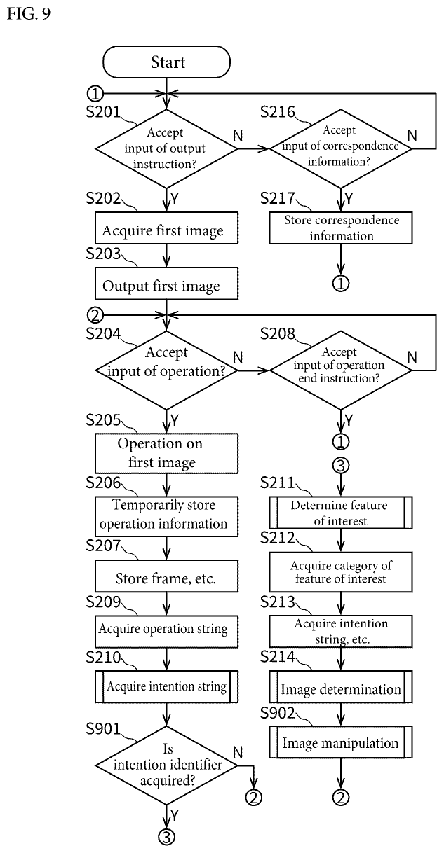

Next, a second operation example of the image processing apparatus 1 will be described with reference to the flowchart in FIG. 9. Here, steps that are identical to those in the flowchart in FIG. 2 shall be omitted from the description of the flowchart in FIG. 9.

(S901) The intention-string acquirer 131 determines whether any intention identifier has been acquired in S210. If the intention identifier has been acquired, the processing proceeds to S211, and if not, then the processing returns to S204. In S210, normally one intention identifier at maximum is acquired by using the operation string that is the set of one or two or more operation identifiers.

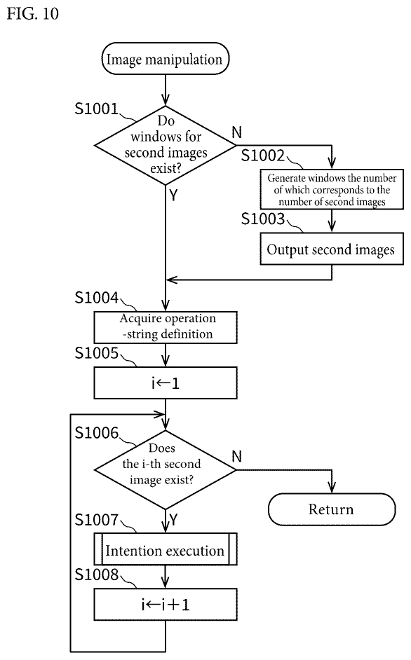

(S902) The operation unit 136 performs the operation corresponding to the intention identifier stored in S210 on the one or more second images determined in S214. Then, the processing returns to S201. An example of this image manipulation processing will be described later with reference to the flowchart in FIG. 10.

In the flowchart in FIG. 9, while the user is manipulating the first image, one or more second images are automatically output and then manipulated according to the user's intention.

In the flowchart in FIG. 9, the processing ends at power-off or upon receipt of an interrupt request to end the processing.

Next, the example of the image manipulation processing performed in S902 will be described with reference to FIG. 10.

(S1001) The second output unit 142 determines whether there are windows for the second images. If the windows for the second images exist, the processing proceeds to S1004, and if not, then the processing proceeds to S1002.

(S1002) The second output unit 142 acquires the number of second images acquired. The second output unit 142 generates windows, the number of which corresponds to the number of second images.

(S1003) The second output unit 142 outputs each of the acquired one or more second images to each corresponding window.

(S1004) The operation unit 136 references to the correspondence manager 113 and acquires the operation-string definition corresponding to the intention identifier acquired in S210.

(S1005) The operation unit 136 substitutes one into the counter i.

(S1006) The operation unit 136 determines whether there is the i-th second image targeted for the operations. If the i-th second image exists, the processing proceeds to S1007, and if not, then the processing returns to the upper-level processing.

(S1007) The operation unit 136 performs the operation corresponding to the intention identifier acquired in S210 on the i-th second image by using the operation-string definition acquired in S1004. One example of the intention execution processing has been described above with reference to the flowchart in FIG. 8.

(S1008) The operation unit 136 increments the counter i by one. Then, the processing returns to S1006.

A specific operation example of the image processing apparatus 1 according to the present embodiment will be described hereinafter.

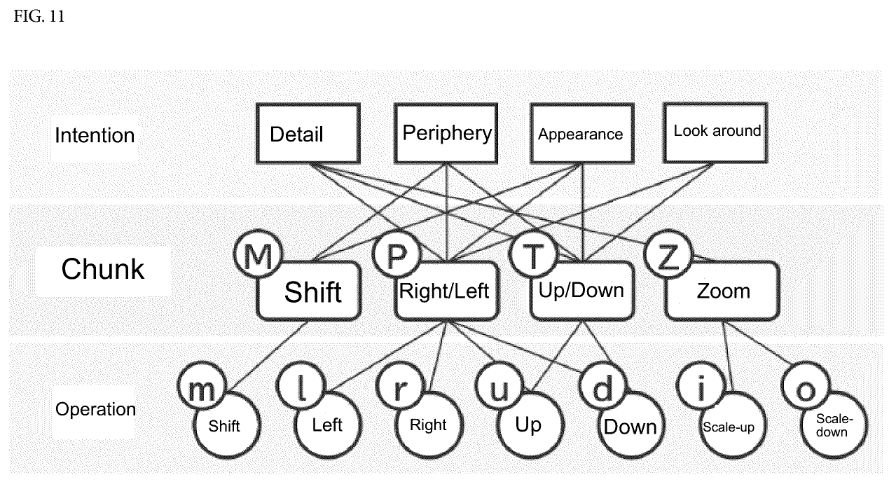

FIG. 11 is a diagram for describing an example of a concept regarding the image processing apparatus 1. The image processing apparatus 1 performs an operation of determining one or more chunks from one or more operations performed on the first image by a user, determining an intention from a string of the chunks, and reflecting the intention on the second images. As described above, the image processing apparatus 1 may perform an operation of determining an intention from one or more operations performed on the first image by a user and reflecting the intention on the second images. That is, it is not an absolute necessity for the image processing apparatus 1 to consider chunks. Two specific examples will be described hereinafter. Specific Example 1 describes a case in which the first image and the second images are position images of the same type. In Specific Example 1, the first image and the second images are street view imagery. Specific Example 2 describes a case in which the first image and the second images are position images of different types. In Specific Example 2, the first image is street view imagery, and the second image is a Google Earth image.

### Specific Example 1

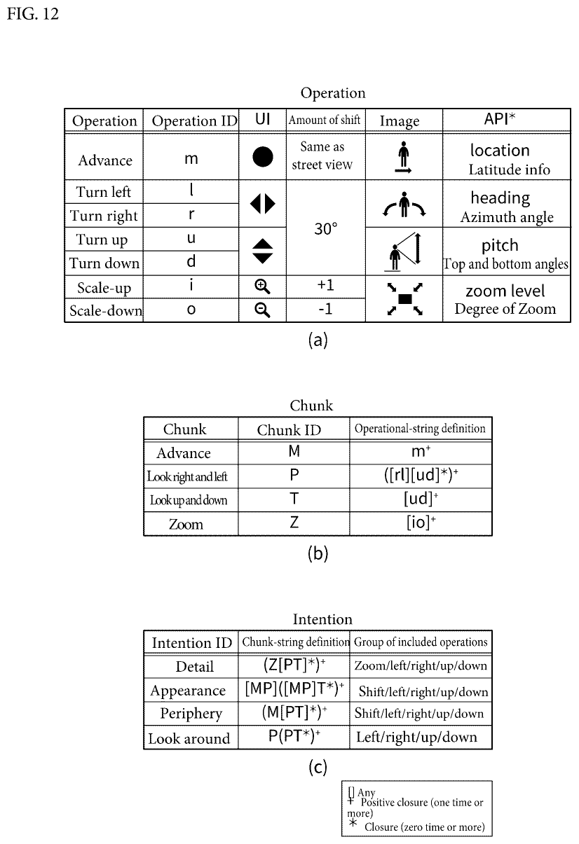

The correspondence manager 113 of the image processing apparatus 1 stores a first correspondence table shown in FIG. 12B and a second correspondence table shown in FIG. 12C. FIG. 12A shows operation identifiers in street view imagery.

The first correspondence table (FIG. 12B) has a plurality of records showing “Chunk”, “Chunk Identifier”, and “Operation-String Definition”. Here, “Chunk” includes “Move”, “Look Right/Left”, “Look Up/Down”, and “Zoom” that respectively have chunk identifiers “M”, “P”, “T”, and “Z”. The operation-string definition corresponding to each chunk identifier is a regular expression using one or more operation identifiers among operation identifiers “m”, “I”, “r”, “u”, “d”, i and “o”. In the regular expression, [ ] denotes the adoption of any of the operation identifiers, +denotes a positive closure (one time or more), and * denotes a closure (zero time or more).

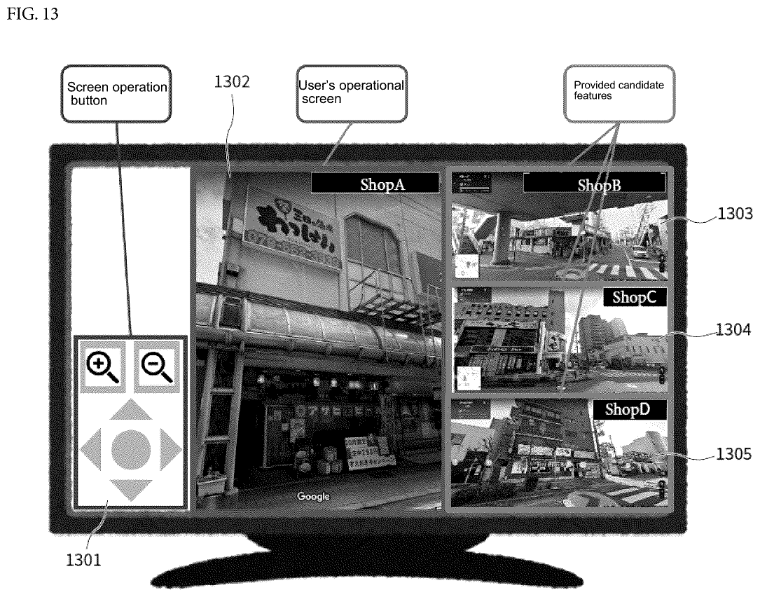

FIG. 13 shows a screen image in the above case. First, suppose that a user has inputted to the image processing apparatus 1 an instruction to output street view imagery that includes a pub as Shop A. Upon receiving this instruction, the image processing apparatus 1 outputs street view imagery 1302 that includes Shop A.

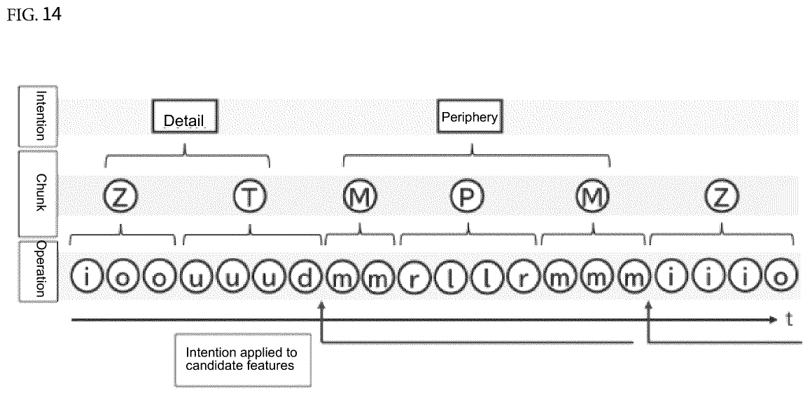

Then, suppose that the user has operated a screen operation button 1301 shown in FIG. 13 to enter an operation string of “i”, “o”, “o”, “u”, “u”, “u”, “d”, “m”, “m”, “r”, “I”, “I”, “r”, “m”, “m”, “m”, “i”, “i”, “i”, and “o” as shown in FIG. 14.

The operation-string acceptor 121 sequentially accepts input of these operations. Then, the intention-string acquirer 131 acquires a chunk identifier “Z” from a partial operation string of “i”, “o”, and “o”, acquires a chunk identifier “T” from a partial operation string of “u”, “u”, “u”, and “d”, a chunk identifier “M” from a partial operation string of “m” and “m”, a chunk identifier “P” from a partial operation string of “r”, “I”, “I”, and “r”, a chunk identifier “M” from a partial operation string of “m”, “m”, and “m”, and a chunk identifier “Z” from a partial operation string of “i”, “i”, “i”, and “o”. That is, the intention-string acquirer 131 references to the first correspondence table (FIG. 12(b)) and acquires a chunk string of “Z”, “T”, “M”, “P”, “M”, and “Z” from the operation string of “i”, “o”, “o”, “u”, “u”, “u”, “d”, “m”, “m”, “r”, “I”, “I”, “r”, “m”, “m”, “m” “i”, “i”, “i”, and “o”.

Then, the intention-string acquirer 131 acquires an intention identifier representing “Detail” from a chunk string of “Z” and “T” and an intention identifier representing “Periphery” from a chunk string of “M”, “P”, and “M”. That is, the intention-string acquirer 131 references to the second correspondence table (FIG. 12(c)) and acquires the intention strings “Detail” and “Periphery” from the acquired chunk string.

Then, the feature-of-interest determiner 132 determines “Shop A” as a feature of interest in the first image 1302 in accordance with the aforementioned algorithm.

Then, the category acquirer 133 acquires a category “Pub” included in the feature information on the feature of interest “Shop A” from the feature manager 111. Then, the intention-string acquirer 131 stores the acquired intention strings “Detail” and “Periphery” and the acquired category “Pub” in a buffer (not shown).

Then, the image determiner 134 determines three examples of street view imagery each including a pub and a feature, and acquires these three examples of street view imagery from an image server (not shown), the feature being a target feature of the category “Pub” that corresponds to positional information close to the positional information on “Shop A” and being one of features of top three establishments (“Shop B”, “Shop C”, and “Shop D”) closest in distance to “Shop A”. These second images are indicated by reference signs 1303, 1304, and 1305 in FIG. 13.

Then, the operation unit 136 performs operations corresponding to the intention strings “Detail” and “Periphery” on each of the three examples of street view imagery (1303 to 1305) in accordance with the aforementioned algorithm.

As a result, the user is able to see an image in which the three examples of street view imagery are manipulated automatically and to check “Detail” and “Periphery” of “Shop B”, “Shop C”, and “Shop D”.

### Specific Example 2

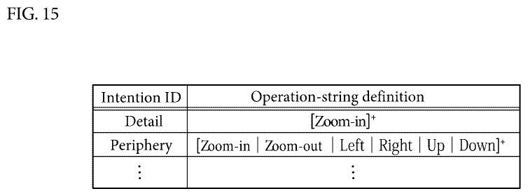

The correspondence manager 113 of the image processing apparatus 1 stores a correspondence table shown in FIG. 15. The correspondence table has a plurality of records showing “Intention Identifier” and “Operation-String Definition”. This correspondence table is for manipulation of Google Earth images.

In Specific Example 2, as a result of a user performing operations similar to those described in Specific Example 1, the image processing apparatus 1 outputs the street view imagery 1302 including Shop A, and the intention-string acquirer 131 acquires the intention strings “Detail” and “Periphery”. The feature-of-interest determiner 132 determines “Shop A” as the feature of interest in the first image 1302 in accordance with the aforementioned algorithm. The processing up to this point is the same as the processing described in Specific Example 1.

Then, the intention-string acquirer 131 stores the acquired intention strings, i.e., “Detail” and “Periphery”, and the acquired feature of interest, i.e., “Shop A”, in a buffer (not shown).

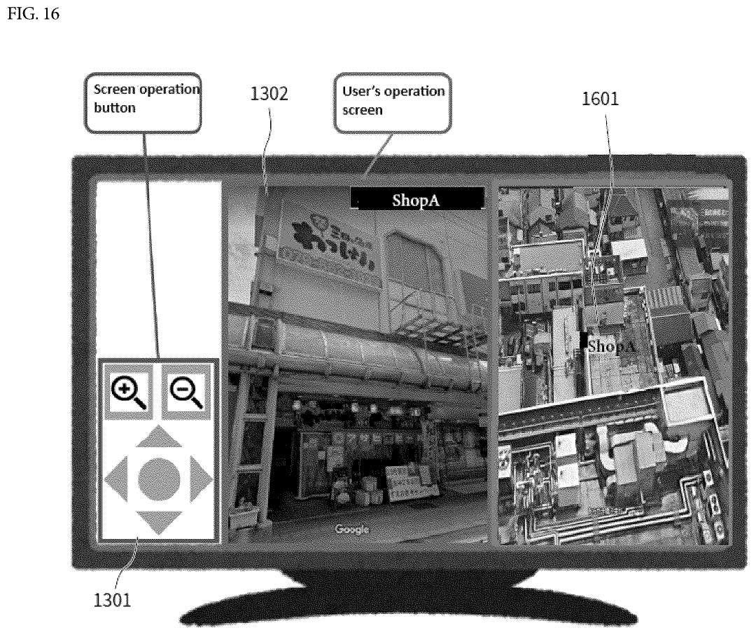

Then, the image determiner 134 inputs “Shop A” as the feature of interest to a Google Earth image and outputs the Google Earth image including “Shop A”. This output image is denoted by a reference sign 1601 in FIG. 16.

Then, the operation unit 136 acquires [Zoom-in]⁺ as the operation-string definition that pairs with “Detail” as the intention identifier from the correspondence table (FIG. 15). The operation unit 136 also acquires the operation-string definition [Zoom-in |Zoom-out | Left| Right| Up| Down]⁺ that pairs with the intention identifier “Periphery” from the correspondence table (FIG. 15).

Then, the operation unit 136 repeats zooming in on the Google Earth image 1601 in accordance with the operation-string definition “Zoom-in” until positional information on the focal point in the Google Earth image 1601 indicates a predetermined distance with respect to positional information on “Shop A”. Then, the operation unit 136 randomly selects any of the operations including zoom-in, zoom-out, turn left, turn right, turn up, and turn down in accordance with the operation-string definition of [Zoom-in |Zoom-out |Left| Right| Up| Down]⁺ based on the intention identifier “Periphery” during a period of time in which the first screen 1302 is being operated, and provides “Periphery” of “Shop A” to the user by means of the Google Earth image.

In the specific examples, the correspondence table for the position images of each type (the first image or the second images) may be a single correspondence table as shown in FIG. 15, or may be configured by two or more correspondence tables as shown in FIGS. 12B and 12C. That is, the correspondence table may be configured by correspondence information as shown in FIG. 15, or may be configured by the first correspondence information and the second correspondence information.

As described thus far, according to the present embodiment, the intention of the operations performed on the first image can be diverted to each of the one or more second images that are different in type from the first image, and as a result, the second images can be manipulated automatically according to the user's intention.

According to the present embodiment, the intention of the operations performed on the first image can be diverted to each of the one or more second images that are different in type from the first image, and as a result, each second image can be manipulated automatically according to the user's intention.

Yet more, according to the present embodiment, the second images can also be determined automatically.

The present embodiment allows reuse of the intention information that specifies the intention of an operation that is performed on the first image.

Note that the processing according to the present embodiment may be realized by software. This software may be distributed by, for example, downloading of the software. This software may be spread via a recording medium such as a CD-ROM on which the software is recorded. This also applies to other embodiments in the specification of the present invention. Note that the software for realizing the image processing apparatus 1 according to the present embodiment may be a program as described below. That is, this program is for causing a computer to function as the first output unit, the operation-string acceptor, the intention-string acquirer, the second output unit, and the operation function. The computer is capable of accessing the correspondence manager that stores two or more pieces of correspondence information each indicating a correspondence between the operation-string definition and the intention identifier, the operation-string definition defining a set of operation identifiers that correspond respectively to two or more operations, the intention identifiers identify the intention of the operations performed on a first image. The first output unit outputs the first image associated with positional information. The operation-string acceptor accepts input of an operation string that is a set of two or more operation identifiers each identifying two or more operations performed on the first image. The intention-string acquirers acquires, from the correspondence manger, an intention string that is a set of intention identifiers corresponding respectively to one or more operation-string definitions that match the operation string accepted by the operation-string acceptor. The second output unit outputs the second image. The operation unit performs one or more operations on the second image, the one or more operations satisfying the operation-string definition corresponding to the intention string acquired by the intention-string acquirer.

### Embodiment 2

The present embodiment describes an image processing apparatus 2 that puts an intention string into circulation, the intention string being acquired by manipulating the first image, and utilizes the intention string to manipulate second images.

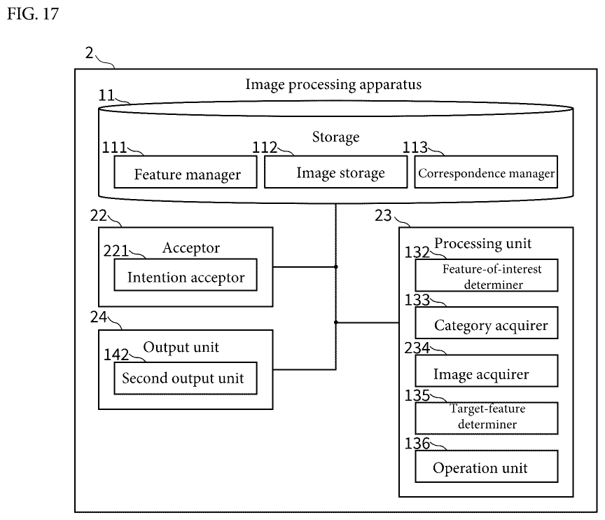

FIG. 17 is a block diagram of the image processing apparatus 2 according to the present embodiment. The image processing apparatus 2 may be a standalone device, or may be a server that receives input of instructions or information from a terminal device (not shown) and transmits position images to the terminal device. In the case where the image processing apparatus 2 is a standalone device, for example, the image processing apparatus 2 may be a so-called personal computer, smartphone, or digitizing tablet, and the type thereof does not matter here. In the case where the image processing apparatus 2 is a server, for example, the image processing apparatus 2 may be a cloud server or an ASP server, and the type thereof does not matter here.

The image processing apparatus 2 includes a storage 11, an acceptor 22, a processing unit 23, and an output unit 24. The acceptor 22 includes an intention acceptor 221. The processing unit 23 includes a feature-of-interest determiner 132, a category acquirer 133, an image acquirer 234, a target-feature determiner 135, and an operation unit 136. The output unit 24 includes a second output unit 142.

The acceptor 22 accepts input of a variety of instructions and information. Examples of the variety of instructions and information may include intention information described later, automated operation instructions, and intention strings and so on.

The automated operation instructions are instructions to manipulate the second images automatically. For example, the automated operation instructions may include identifiers that identify position images targeted for operation. The position images targeted for operation are second images. The automated operation instruction may include information for use in identifying an intention string.

The intention strings and so on may be only the intention strings, may be the intention strings and categories, or may be the intention strings and target feature identifiers. The categories are categories of target features. The target feature identifiers refer to information for use in identifying target features. For example, the target feature identifiers may be the names or IDs of features targeted for operation.

The intention acceptor 221 accepts input of intention information. The intention information as used herein refers to information for use in identifying user's intention to the position images. The intention information includes intention strings. The intention strings are information acquired depending on the operations performed on the first image. It is preferable that the intention information may include intention strings and also categories. The intention information may include intention strings and target feature identifiers.

The processing unit 23 performs a variety of processing. Examples of the variety of processing include processing performed by the feature-of-interest determiner 132, processing performed by the category acquirer 133, processing performed by the image acquirer 234, processing performed by the target-feature determiner 135, and processing performed by the operation unit 136.

The image acquirer 234 acquires second images that are to be manipulated automatically. For example, the image acquirer 234 may acquire the second images by using identifiers of position images included in the automated operation instruction. For example, the image acquirer 234 may acquire the second images from the image storage 112 or an image server (not shown). Note that the first image and the second images may be of the same type, or may be of different types.

The output unit 24 outputs a variety of information. Examples of the variety of information include the second images acquired by the image acquirer 234.

The language “output” as used herein refers to, for example, transmission of the information to a user's terminal device (not shown), but it may represent a concept that includes, for example, display of the information on a display, projection of the information via a projector, printing of the information using a printer, transmission of the information to other external devices, storage of the information in a recording medium, and transfer of the result of processing the information to other processing devices or programs.

It is preferable that the acceptor 22 and the intention acceptor 221 are realized as wired or wireless communication means, but they may be realized as any other means such as means for receiving a broadcast, a device driver for input means such as a touch panel or a keyboard, or software for controlling a menu screen.

The processing unit 23 and the image acquirer 234 may be normally realized as, for example, processors or memory. The procedure of processing performed by the processing unit 23 is normally realized by software that is recorded on a recording medium such as a ROM. Alternatively, the procedure of processing may be realized by hardware (a dedicated circuit). Note that the processor may, for example, be a CPU, a MPU, or a GPU, and the type of the processor does not matter here.

The output unit 24 is normally realized as wired or wireless communication means, but it may be realized as driver software for output devices such as a display or a speaker, or may be realized as a combination of an output device and driver software for the output device.

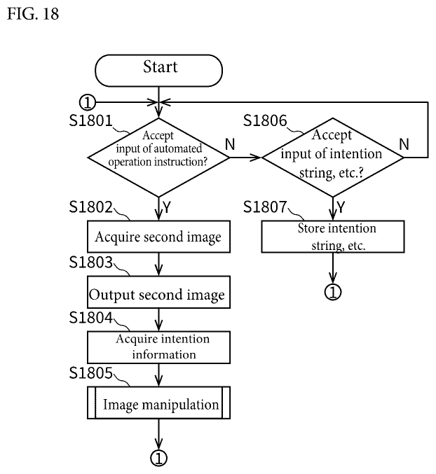

Next, an operation example of the image processing apparatus 2 will be described with reference to the flowchart in FIG. 18.

(S1801) The acceptor 22 determines whether an automated operation instruction has been accepted. If the automated operation instruction has been accepted, the processing proceeds to S1802, and if not, then the processing proceeds to S1806.

(S1802) The image acquirer 234 acquires second images by using an identifier of a position image included in the automated operation instruction. The second images are position images to be manipulated automatically.

(S1803) The second output unit 142 outputs the second images acquired in S1802.

(S1804) The intention acceptor 221 acquires intention information. For example, the intention acceptor 221 may acquire the intention information stored in the storage 11. For example, the intention acceptor 221 may acquire the intention information included in the automated operation instruction. For example, the intention acceptor 221 may acquire intention information that is identified by the identifier of the intention information included in the automated operation instruction.

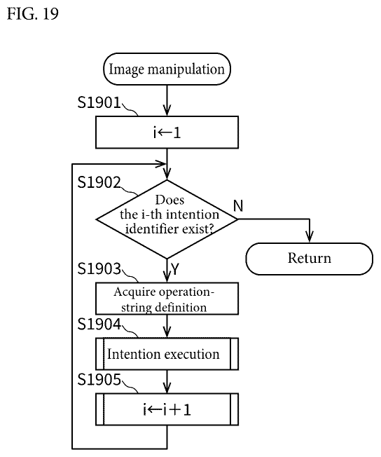

(S1805) The operation unit 136 manipulates the second images output in S1803 by using the intention information acquired in S1804. An example of this image manipulation will be described later with reference to the flowchart in FIG. 19.

(S1806) The intention acceptor 221 determines whether an intention string or the like has been accepted. If the intention string or the like has been accepted, the processing proceeds to S1807, and if not, then the processing proceeds to S1801.

(S1807) The processing unit 23 stores the intention string or the like accepted in S1806 in the storage 11. Then, the processing returns to S1801. Note that the intention string or the like as used herein refers to the intention information. For example, the intention string or the like may be the intention string and the category, or may be the intention string and the feature identifier, or may only be the intention string.

In the flowchart in FIG. 18, the processing ends at power-off or upon receipt of an interrupt request to end the processing.

Next, the example of the image manipulation performed in S1805 will be described with reference to the flowchart in FIG. 19.

(S1901) The operation unit 136 substitutes one into a counter i.

(S1902) The operation unit 136 determines whether the i-th intention identifier is included in the acquired intention string. If the i-th intention identifier exists, the processing proceeds to S1903, and if not, then the processing proceeds to the upper-level processing.

(S1903) The operation unit 136 references to the correspondence manager 113 and acquires a operation-string definition that corresponds to the i-th intention identifier.

(S1904) The operation unit 136 performs operation corresponding to the i-th intention identifier on the output second images by using the operation-string definition acquired in S1903. An example of this intention execution processing has been described with reference to the flowchart in FIG. 8.

(S1905) The operation unit 136 increments the counter i by one. Then, the processing returns to S1902.

A specific operation example of the image processing apparatus 2 according to the present embodiment will be described hereinafter. Suppose that intention strings “Detail” and “Periphery” that pair with the intention string identifier “Intention X” is stored in the storage 11 of the image processing apparatus 2.

In this situation, supposed that the user has inputted the automated operation instruction including the feature of interest “Shop A” and the intention string identifier “Intention X” to the image processing apparatus 2.

Upon receiving this instruction, the acceptor 22 accepts input of the automated operation instruction expressed as “<Feature of Interest> Shop A <Intention String Identifier> Intention X”.

Then, the image acquirer 234 acquires street view imagery that includes “Shop A” by using “<feature of interest> Shop A” included in the automated operation instruction. The category acquirer 133 acquires the category “Pub” of “Shop A”. Then, the target-feature determiner 135 determines a predetermined number of (here, three) features, i.e., “Shop B”, “Shop C”, and “Shop D”, that are features of the category “Pub” and that have short distances from “Shop A”. Then, the image acquirer 234 acquires the three examples of street view imagery that respectively include the features “Shop B”, “Shop C”, and “Shop D” from an image server (not shown).

Then, the output unit 24 outputs four examples of street view imagery that respectively include “Shop A”, “Shop B”, “Shop C”, and “Shop D”.

Then, the operation unit 136 automatedly manipulates the four examples of street view imagery by applying the intention strings “Detail” and “Periphery”, which pair with the intention string identifier “Intention X”, to the four examples of street view imagery, using each of “Shop A”, “Shop B”, “Shop C”, and “Shop D” as a target feature. This manipulation has been described in the specific example of Embodiment 1.

Then, for example, the output unit 24 may output the four examples of street view imagery, respectively, to the windows 1302 to 1305 in FIG. 13.

As described thus far, according to the present embodiment, it is possible to reuse the intention information for use in identifying the intention of operations performed on the first image. That is, according to the present embodiment, the intention of the operations performed on the first image can be diverted to each of the one or more second images, and as a result, the one or more second images can be manipulated automatically according to the user's intention.

Moreover, according to the present embodiment, the second images can be determined automatically.

Note that software for realizing the image processing apparatus 2 according to the present embodiment may be a program as described below. That is, the program is for causing a computer to function as the intention acceptor, the second output unit, and the operation unit. The computer is capable of accessing the correspondence manager that stores two or more pieces of correspondence information each indicating a correspondence between the operation-string definition and the intention identifier. The intention acceptor accepts input of intention information that includes the intention string acquired in response to the operations performed on the first image. The second output unit outputs the second images. The operation unit acquires operation-string definitions that correspond respectively to one or more intention identifiers included in the intention information accepted by the intention acceptor and performs one or more operations that satisfy the one or more operation-string definitions on the second image.

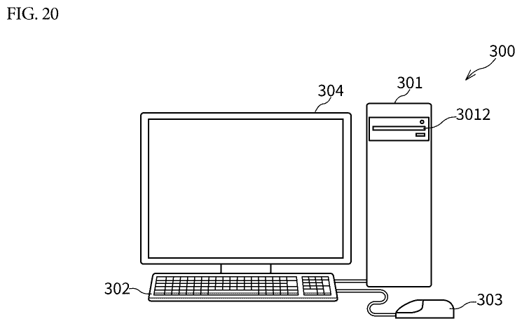

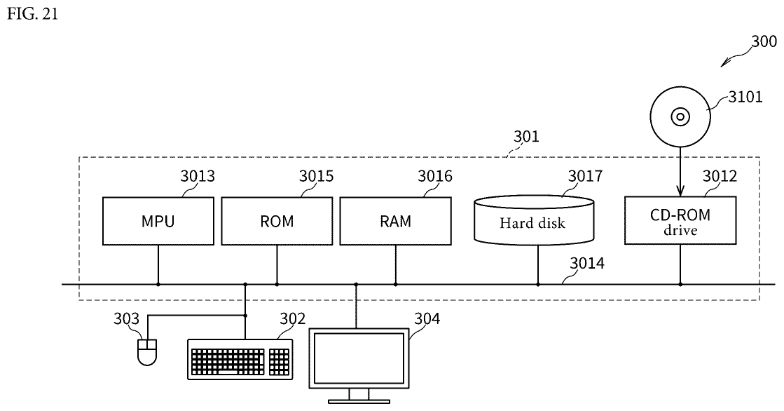

FIG. 20 shows the outer appearance of the computer that realizes the image processing apparatus 1 or 2 according to the various embodiments described above by executing the program described in the specification of the present invention. The embodiments described above may be realized by computer hardware and computer programs that are executed on the computer hardware. FIG. 20 is an overview image of such a computer system 300, and FIG. 21 is a block diagram of the system 300.

In FIG. 20, the computer system 300 includes a computer 301 that includes a CD-ROM drive 3012, a keyboard 302, a mouse 303, and a monitor 304.

In FIG. 21, the computer 301 includes, in addition to the CD-ROM drive 3012, an MPU 3013, a bus 3014 connected to the CD-ROM drive 3012 and so on, ROM 3015 for storing programs such as a bootup program, RAM 3016 that is connected to the MPU 3013 and provides a temporary storage space while temporarily storing instructions of application programs, and a hard disk 3017 for storing data, system programs, and application programs. Although not shown, the computer 301 may further include a network card that provides connection to a LAN.

The program for causing the computer system 300 to execute the functions of the image processing apparatus 1 and so on according to the above-described embodiments may be stored in a CD-ROM 3101, may be installed into the CD-ROM drive 3012, or may be transferred to the hard disk 3017. Instead of this, the program may be transmitted to the computer 301 via a network (not shown) and stored in the hard disk 3017. The program may be loaded into the RAM3016 at the time of execution. The program may be loaded directly from the CD-ROM3101 or the network.

The program does not always have to include an operating system (OS), a third-party program, or the like that causes the computer 301 to execute the functions of the image processing apparatus 1 or the like according to the above-described embodiments. The program may only include instruction parts that invokes an appropriate function (module) in a controlled mode so as to achieve a described result. The way of operating the computer system 300 is well-known, and therefore a detailed description thereof shall be omitted.

In the program described above, steps such as the step of transmitting information or the step of receiving information does not include processing performed by hardware such as processing performed by a modem or an interface in the transmission step (i.e., processing performed only by hardware).

The computer executing the above-described program may be a single computer or may be configured by multiple computers. That is, the above computer may perform centralized processing or may perform distributed processing.

It goes without saying that, in each of the above-described embodiments, two or more communication means that exist in one device may be physically realized by one medium.

In each of the above-described embodiments, each processing may be realized by centralized processing performed by a single device, or may be realized by distributed processing performed by a plurality of devices.

It goes without saying that the present invention is not intended to be limited to the embodiments described above, and various modifications are possible and are also included in the scope of the present invention.

### REFERENCE SIGNS LIST

1, 2 image processing apparatus
11 storage
12, 22 acceptor
13, 23 processing unit
14, 24 output unit
111 feature manager
112 image storage
113 correspondence manager
121 operation-string acceptor
131 intention-string acquirer
132 feature-of-interest determiner
133 category acquirer
134 image determiner
135 target-feature determiner
136 operation unit
141 first output unit
142 second output unit
221 intention acceptor
234 image acquirer

1. An image processing apparatus comprising:
a correspondence manager that stores two or more pieces of correspondence information each indicating a correspondence between an operation-string definition and an intention identifier, the operation-string definition defining a set of operation identifiers that correspond respectively to two or more operations, the intention identifier identifying an intention of the two or more operations;
a first output unit that outputs an image associated with positional information as a first image;
an operation-string acceptor that accepts input of an operation string that is a set of operation identifiers that respectively identify two or more operations performed on the first image;
an intention-string acquirer that acquires an intention string from the correspondence manager, the intention string being a set of intention identifiers that correspond respectively to one or more operation-string definitions that match the operation string accepted by the operation-string acceptor;
a second output unit that outputs a second image; and
an operation unit that performs one or more operations on the second image, the one or more operations satisfying the operation-string definition corresponding to the intention string acquired by the intention-string acquirer.

2. The image processing apparatus according to claim 1, wherein
the correspondence manager stores two or more pieces of first correspondence information and two or more pieces of second correspondence information, the two or more pieces of first correspondence information each indicating a correspondence between the operation-string definition and a chunk identifier that identifies a chunk as a cluster of operations, the two or more pieces of second correspondence information each indicating a correspondence between the intention identifier and a chunk-string definition that defines a chunk string as a set of one or more chunk identifiers,
the intention-string acquirer acquires one or more chunk strings from the two or more pieces of first correspondence information and acquires one or more intention identifiers from the two or more pieces of second correspondence information, the one or more chunk strings each being a set of one or more chunk identifiers that correspond respectively to one or more operation-string definitions that match the operation string accepted by the operation-string acceptor, the one or more intention identifiers corresponding respectively to chunk-string definitions that match the one or more chunk strings.

3. The image processing apparatus according to claim 2, further comprising:
a feature-of-interest determiner that references to a feature manager to determine a feature of interest by using the positional information associated with the first image, the feature manager storing two or more pieces of feature information each including a feature identifier and two or more feature attribute values, the feature identifier identifying a feature, the two or more feature attribute values including a category of the feature and positional information on the feature, the feature of interest being a feature in the first image and satisfying a condition of interest;
a category acquirer that acquires a category of the feature of interest from the feature manager; and
a target-feature determiner that determines a target feature that is a feature in the second image and that is a feature of the same category as the category acquired by the category acquirer,
wherein the operation unit performs one or more operations on the target feature, the one or more operations satisfying operation-string definitions that correspond respectively to the one or more intention identifiers acquired by the intention-string acquirer.

4. The image processing apparatus according to claim 3, wherein
the operation unit performs the one or more operations on the target feature by using positional information on the target feature to maintain a positional relationship with the target feature according to intentions identified by the one or more intention identifiers.

5. The image processing apparatus according to claim 4, wherein
the operation-string definition defines one or more operation identifiers using a regular expression;
the chunk-string definition defines one or more chunk identifiers using the regular expression;
the operation unit changes an iteration count of the one or more chunk identifiers, changes selection of the one or more chunk identifiers, changes an iteration count of the one or more operation identifiers, or changes selection of the one more operation identifiers and performs the one or more operations on the target feature by using the positional information on the target feature to maintain a positional relationship with the target feature according to the intentions identified by the intention identifiers.

6. The image processing apparatus according to claim 3, further comprising:
an image determiner that acquires a position image from an image storage that stores two or more position images, the position image including a feature of the same category as the category acquired by the category acquirer,
wherein the second image is the position image acquired by the image determiner.

7. The image processing apparatus according to claim 6, wherein
the image determiner determines one or more second images that include a feature of the same category as the category acquired by the category acquirer and that are associated with positional information that satisfies a condition of a position with respect to the positional information associated with the first image, and
the operation unit performs one or more operations on each of the one or more second images determined by the image determiner, the one or more operations satisfying operation-string definitions that correspond respectively to the one or more intention identifiers acquired by the intention-string acquirer.

8. The image processing apparatus according to claim 1, wherein
the first image and the second image are each one of street view imagery, a three-dimensional image, an indoor image, and a drive recorder image.

9. An image processing method realized by a correspondence manager, a first output unit, an operation-string acceptor, an intention-string acquirer, a second output unit, and an operation unit,
the correspondence manager storing two or more pieces of correspondence information each indicating a correspondence between an operation-string definition and an intention identifier, the operation-string definition defining a set of operation identifiers that correspond respectively to two or more operations, the intention identifier identifying an intention of the two or more operations,
the image processing method comprising:
causing the first output unit to output an image associated with positional information as a first image;
causing the operation-string acceptor to accept input of an operation string that is a set of operation identifiers that respectively identify two or more operations performed on the first image;
causing the intention-string acquirer to acquire an intention string from the correspondence manager, the intention string being a set of intention identifiers that correspond respectively to one or more operation-string definitions that match the operation string accepted by the operation-string acceptor;
causing the second output unit to output a second image; and
causing the operation unit to perform one or more operations on the second image, the one or more operations satisfying the operation-string definition that corresponds to the intention string acquired by the intention-string acquirer.

10. A recording medium for use in a computer capable of accessing a correspondence manager that stores two or more pieces of correspondence information each indicating a correspondence between an operation-string definition and an intention identifier, the operation-string definition defining a set of operation identifiers that correspond respectively to two or more operations, the intention identifier identifying an intention of the two or more operations,
the recording medium having recorded thereon a program for causing the computer to function as:
a first output unit that outputs an image associated with positional information as a first image;
an operation-string acceptor that accepts input of an operation string that is a set of operation identifiers that respectively identify two or more operations performed on the first image;
an intention-string acquirer that acquires an intention string from the correspondence manager, the intention string being a set of intention identifiers that correspond respectively to one or more operation-string definitions that match the operation string accepted by the operation-string acceptor;
a second output unit that outputs a second image; and
an operation unit that performs one or more operations on the second image, the one or more operations satisfying the operation-string definition that corresponds to the intention string acquired by the intention-string acquirer.
